(19) United States
(12) Patent Application Publication
(10) Pub. No.: US 2007/0193704 A1
(43) Pub. Date: Aug. 23, 2007

(54) Overhead Wood Door With Inset Strut, and Methods

(76) Inventors: Michael H. Brown Jr., River Falls, WI (US); Kent H. Forsland, River Falls, WI (US)

Correspondence Address: MERCHANT & GOULD PC, P.O. BOX 2903, MINNEAPOLIS, MN, 55402-0903, US

(21) Appl. No.: 11/276,287

(22) Filed: Feb. 22, 2006

(51) Int. Cl. E05D 15/00

(52) U.S. Cl. 160/201

(57) ABSTRACT

A sectional wood overhead door used to create access to building interiors in residential and commercial applications. The door includes an inset lateral reinforcing strut, U-bar, brace, or other reinforcing member, with the strut being inset at least partially into the door. No portion of the strut extends out from or above a surface of the door. When the door is installed for use, the inset struts do not extend past the interior surface of the door. In some designs, the inset struts are concealed and are not visible or otherwise discernable by one looking at or otherwise examining the internal surface of the door.

### FIELD

The present invention generally relates to sectional wood overhead doors used to create access to building interiors in residential and commercial applications. More specifically, the present invention relates to sectional wood overhead doors having inset or internal reinforcing members.

### BACKGROUND

Sectional overhead doors are frequently used to create access to building interiors in residential and commercial applications. Such doors are commonly referred to as “overhead garage doors”, or merely “garage doors”.

In today's society, numerous people are installing custom garage doors, particularly doors that have architectural features, such as sections to provide the appearance of double-swing doors or other old-time architectural structure.

To provide a more authentic appearing door than possible with steel or fiberglass, some of today's overhead doors are returning to the original material; that is, they are made from wood. Wood has advantages over steel or fiberglass, by providing a door that can be readily painted or stained or further customized as desired, and by providing a façade that weathers, increasing the old-time authentic appearance. Large wood doors, even though generally solid however, are less strong and stable than steel and fiberglass doors, and have been known to twist or bend under certain uses.

Door manufactures have increased the lateral and torsional strength of wood doors by providing a reinforcing member along the surface of the wood door, generally on the interior side when the door in installed. These reinforcing members are commonly referred to as struts, U-bars, braces, or the like.

Although the reinforcing member, such as a strut, is structurally sound and provides the desired increase in strength, the visual appearance of the door is lacking. Improvements are desired.

### SUMMARY

The present invention provides a wood garage door, typically solid wood, that incorporates aesthetic features while meeting structural standards. In particular, the present invention generally relates to sectional wood overhead doors used to create access to building interiors in residential and commercial applications. The inventive doors include an inset lateral reinforcing member, with the reinforcing member being inset at least partially into the door. No portion of the reinforcing member extends out from or above a surface of the door.

When the door is installed for use, the inset reinforcing members do not extend past the interior surface of the door. Preferably, the inset reinforcing members are not visible or otherwise discernable by one looking at or otherwise examining the internal surface of the door.

Within the application, the term “strut” is used to represent the reinforcing member. The term “strut” is interchangeable with other common terms for reinforcing members such as brace and U-bar.

In one particular aspect, the invention is to a wood door, such as a garage door, that has a plurality of sections hingedly connected, each of the sections comprising a wooden internal frame having a first side, an opposite second side, a first side edge and an opposite second side edge. A first layer is present over the first side and a second layer is present over the second side, each of the first layer and the second layer covering the internal frame. At least one of the sections has an inset strut extending laterally across the section between the first side edge and the second side edge, with no portion of the inset strut extending above a surface of the first layer. The inset strut could be recessed into the first layer or present between the frame and the first layer. The inset strut could have a T-shape. Additionally or alternately, the inset strut could be composed of two pieces, and those two pieces could be L-shaped. More than one of the sections could include an inset strut; for example, two or more, or three or more sections could include an inset strut. When installed, the first layer forms the interior surface of the door.

In another particular aspect, the invention is to a section, such as for a garage door, the section having a wooden internal frame having a first side, an opposite second side, a first side edge and an opposite second side edge. A first layer is present over the first side and a second layer is present over the second side, each of the first layer and the second layer covering the internal frame. An inset strut extends laterally across the section between the first side edge and the second side edge, with no portion of the inset strut extending above a surface of the first layer. The inset strut could be recessed into the first layer or present between the frame and the first layer. The inset strut could have a T-shape. Additionally or alternately, the inset strut could be composed of two pieces, and those two pieces could be L-shaped. The section can be combined with additional sections, either having an inset strut or not, to form a door. When installed, the first layer forms the interior surface of the door.

A more complete appreciation of the present invention and its scope may be obtained from the accompanying drawings that are briefly described below, from the following detailed descriptions of presently preferred embodiments of the invention and from the appended claims.

### BRIEF DESCRIPTION OF THE DRAWING

The invention may be more completely understood in consideration of the following detailed description of various embodiments of the invention in connection with the accompanying drawing, in which:

FIG. 1 is a schematic, front plan view of a house with a garage having two garage doors installed thereon;

FIG. 2 is a plan view of the front, exterior side of a garage door according to the present invention, similar to those illustrated in FIG. 1;

FIG. 3 is a plan view of the back, interior side of a prior art garage door;

FIG. 4 is a plan view of the back, interior side of the garage door of FIG. 2, according to the present invention;

FIG. 5 is an end view of the garage door of FIG. 4;

FIG. 6 is an interior elevation of the interior of the garage door according to the present invention;

FIG. 6A is one section from the door shown in FIG. 6;

FIG. 7 is a front plan view of a reinforcing strut for the garage door according to the present invention;

FIG. 8 is an end plan view of the reinforcing strut of FIG. 7;

FIG. 9 is a front plan view of a top reinforcing member of the garage door according to the present invention;

FIG. 10 is an end plan view of the top reinforcing member of FIG. 9; and

FIG. 11 is a cross-sectional view of a portion of the garage door, taken along line 11-11 of FIG. 6, showing a reinforcing strut and a top reinforcing member installed in the door.

While the invention is amenable to various modifications and alternative forms, specifics thereof have been shown by way of example in the drawing and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

In the following description of preferred embodiments of the present invention, reference is made to the accompanying drawing that forms a part hereof, and in which is shown by way of illustration specific embodiments in which the invention may be practiced. It is understood that other embodiments may be utilized and structural changes may be made without departing from the scope of the present invention.

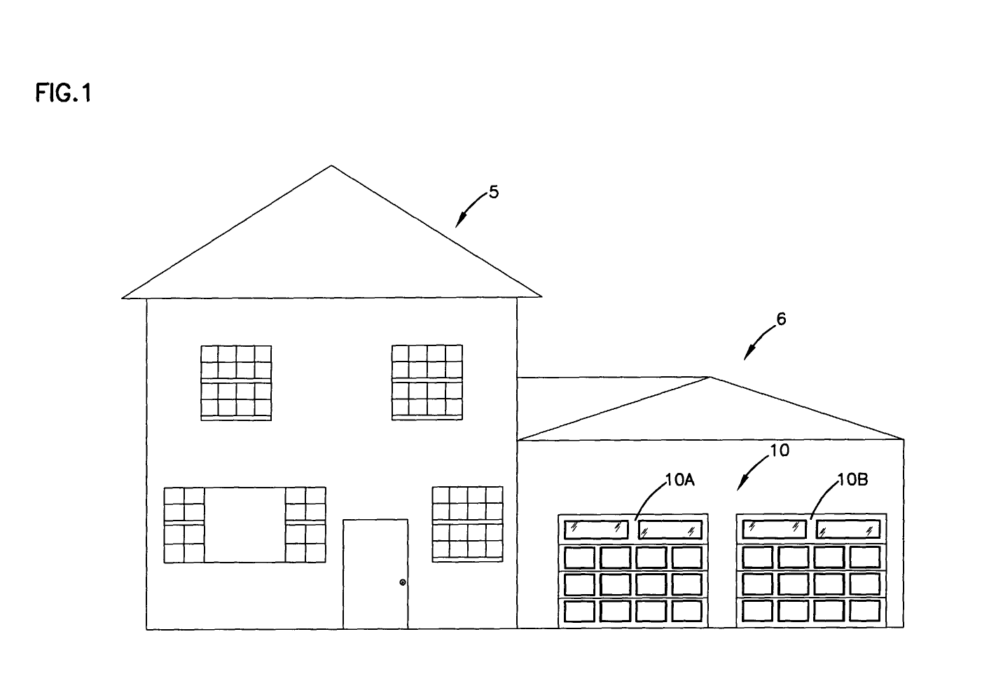

Referring to FIG. 1, a typical, residential house 5 is shown having a garage 6 with side-by-side single garage doors 10, specifically, doors 10A and 10B. Although garage 6 is illustrated as attached to house 5, garage 6 with doors 10A, 10B could be a detached garage. Also, although garage 6 is illustrated with two doors 10, garage 6 could have one door 10, three doors 10, or more.

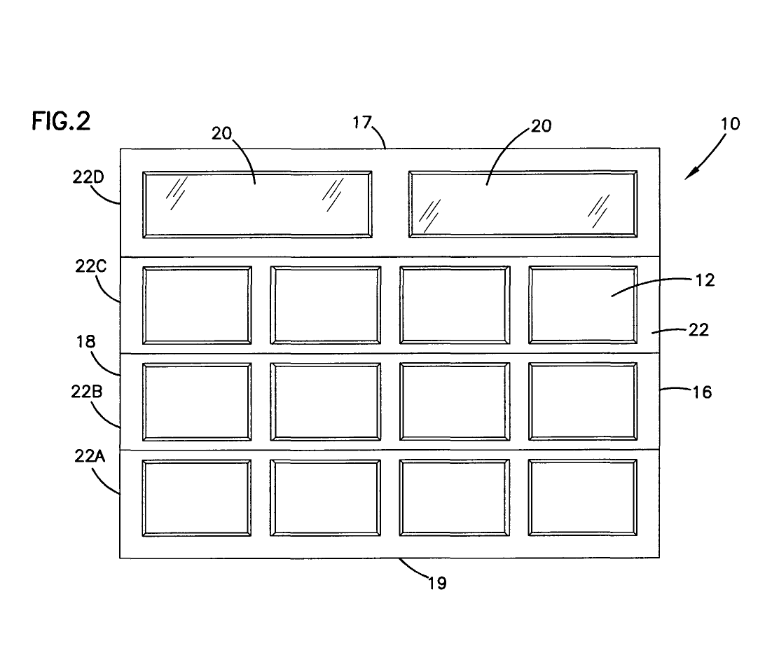

Referring to FIG. 2, garage door 10 is illustrated as seen from the exterior of garage 6. That is, in FIG. 2, the exterior side or surface 12 of door 10 is seen. Door 10 has a first side edge 16, and opposite side edge 18, a top edge 17 and a bottom edge 19.

Typical sizes for door 10, if a single garage door, include 8 ft wide by 7 ft high (96 inches×84 inches), 8 ft by 8 ft (96 inches×96 inches), and 9 ft by 8 ft (108 inches×96 inches). Door 10 as wide as 10½ ft (126 inches) is also possible. Double garage doors are also within the scope of this invention. Typical sizes for door 10, if a double garage door, include 16 ft wide by 7 ft high (192 inches×84 inches), 16 ft wide by 8 ft high (192 inches×by 96 inches), and 18 ft wide by 8 ft high (216 inches×96 inches). It is understood that other sizes, whether single doors, double doors, or special sizes, are possible and within the scope of this invention. The various heights and numbers of the sections that make up door 10 are adjusted to provide the desired door height.

Door 10 can have an ornamental façade on exterior surface 12. In this illustrated embodiment of FIG. 2, the façade includes twelve raised panels and two windows 20. Other façades for door 10 are known and are suitable for use with the present invention. For example, other suitable façades include sections with flat panels, three or four windows, and v-groove. See also, for example, U.S. Pat. Nos. Des. 378,853, Des. 378,421, Des. 380,053, Des. 382.065, Des. 382,066, Des. 382,067, Des. 383,551, Des. 397,446, Des. 397,447, and 6,446,695, all which are incorporated herein by reference and which disclose various façade configurations that are suitable for door 10. One popular façade is that of an old fashioned-looking carriage door, such as a double-swing door.

Door 10 is an overhead door, intended to be supported by and move on side-mounted tracks or rails, as are well known. Door 10 is composed of multiple sections 22; particularly, door 10 in FIG. 2 has bottom section 22A, an internal section such as second section 22B, another internal section such as third section 22C, and fourth or top section 22D. Top section 22D includes windows 20 and is a windowed section 22D; it is understood that having a windowed section is optional.

Door 10 is a “wood” door, meaning, that the structure of door 10 is composed of wood. In certain embodiments, door 10 is a “solid wood” door, made from dimensional lumber, rather than multiple sheets of plywood or other sheeting that is pieced together. There is no appreciable amount of metal in any of the components that make up sections 22; these wood components, along with any metal hardware, are described below.

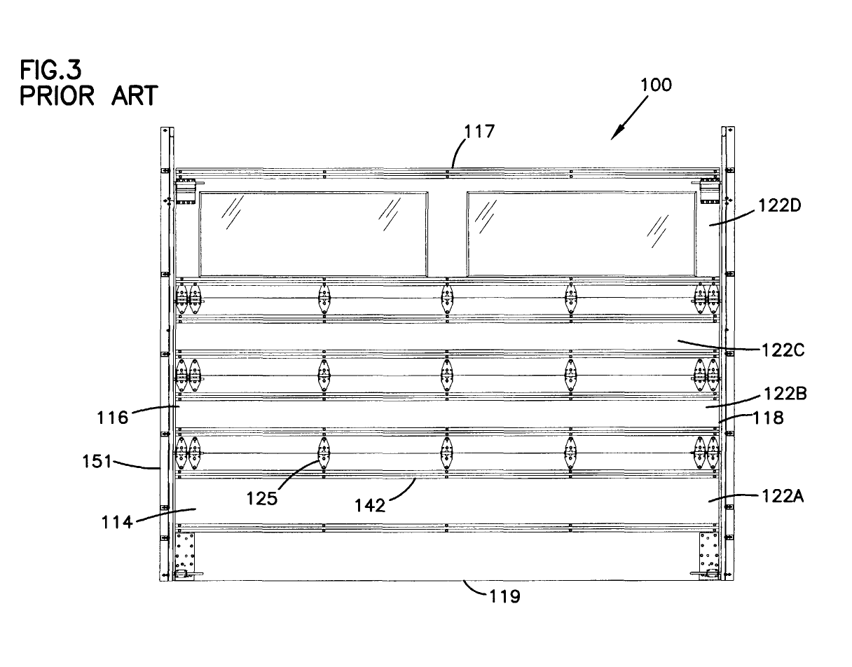

A view of the backside, or the interior side, of a prior art door is illustrated in FIG. 3. This door 100 has an interior surface 114, first side edge 116, second side edge 118, top edge 117, and bottom edge 119, and multiple sections 122A, 122B, 122C, 122D. Sections 122A, 122B, 122C, 122D are movably held together by hinges 125. Present on interior surface 114 are reinforcing struts 142 to increase resistance to flexing from side edge 116 to side edge 118. Each section 122A, 122B, 122C, 122D can have any number of struts 142, although generally one or two struts per section are generally used to provide the desired resistance. Struts 142 are generally fastened to the surface of sections 122A, 122B, 122C, 122D so that struts 142 extend out and away from interior surface 114. That is, at least a portion of strut 142, and typically the entire strut 142, extends into the interior of the garage or other space to which door 100 provides access.

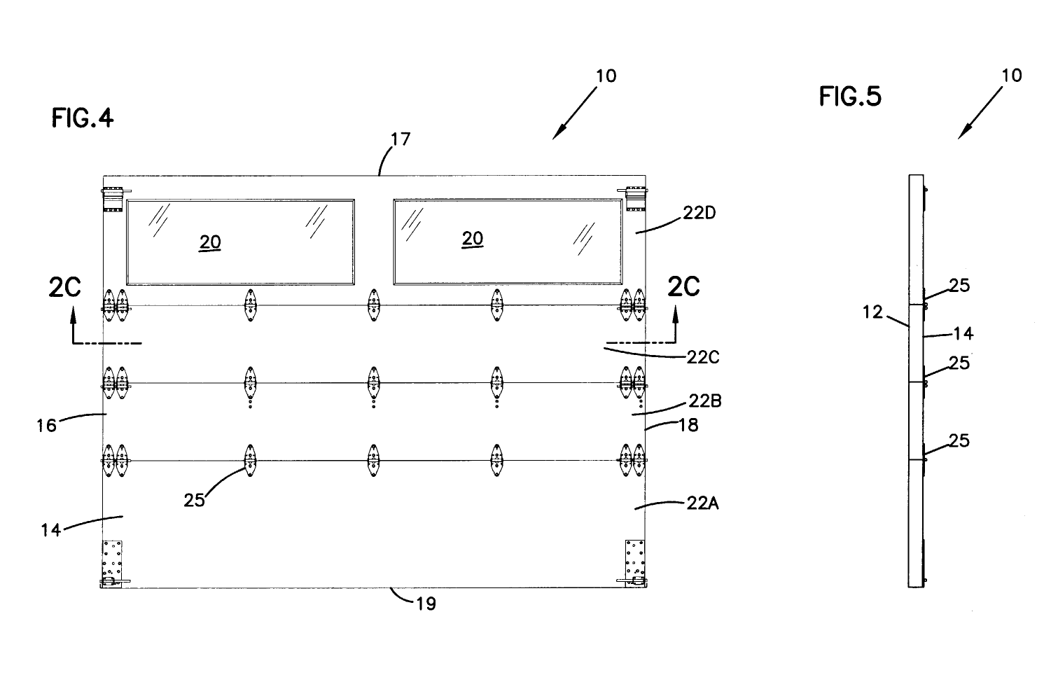

Conversely, a view of the backside, or the interior side, of door 10 according to the present invention is illustrated in FIG. 4. From this side, interior surface 14, first side edge 16, second side edge 18, top edge 17, and bottom edge 19 can be readily seen, as can sections 22A, 22B, 22C, 22D. Sections 22A, 22B, 22C, 22D are movably held together by hinges 25. Hinges 25 allow sections 22A, 22B, 22C, 22D to pivot in relation to one another and allow door 10 to be moveably positioned between open and closed positions, as is typical for overhead garage doors.

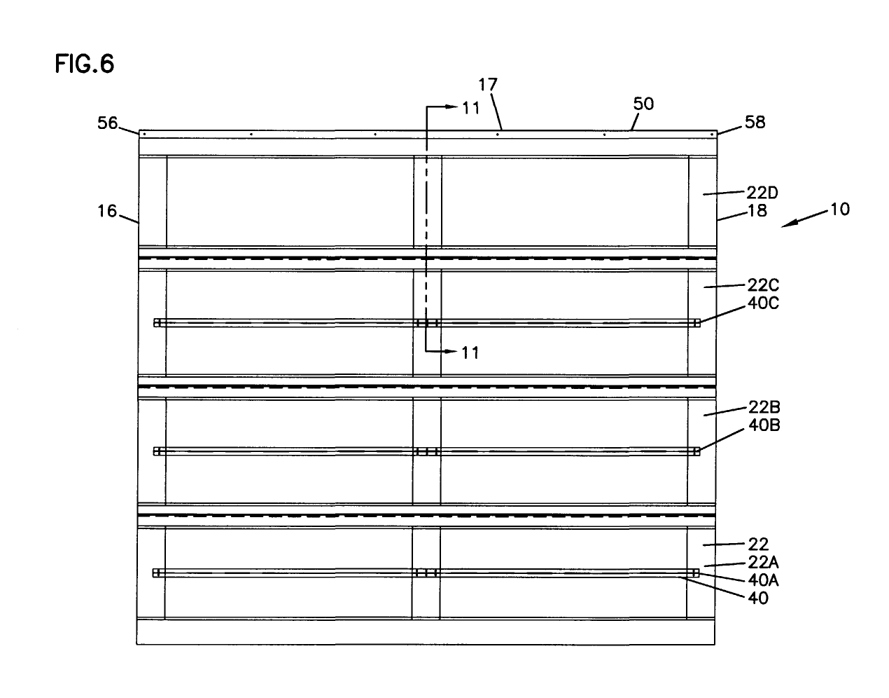

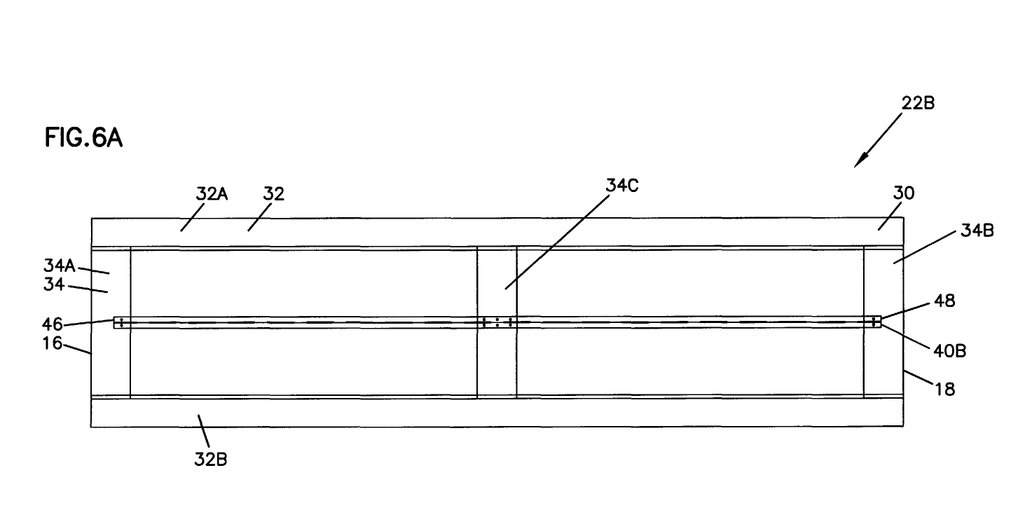

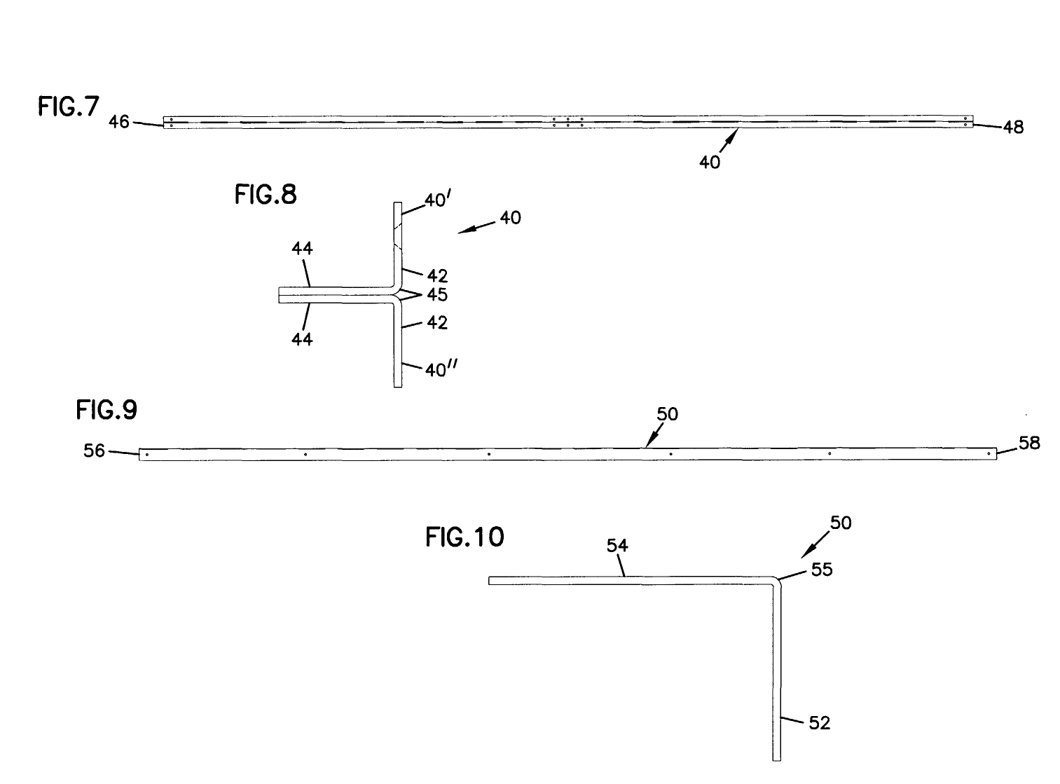

Door 10 includes no reinforcing struts extending into the space to which door 10 provides access, that is, door 10 includes no struts that extend above interior surface 14. In the preferred embodiment, there is no structure, other than hinges 25 and mounting hardware (e.g., roller brackets), that extends out from surface 14. A handle, to facilitate manual lifting or raising of door 10, may be present on interior surface 14. FIG. 5 is a side view of door 10, reinforcing the lack of reinforcing struts on interior surface 14. Door 10 of the present invention includes reinforcing struts within the interior of sections 22, the struts being recessed into or flush with interior surface 14. The internal construction of door 10 can be understood by reference to FIGS. 6, 6A and 7. It is noted that FIGS. 6 and 6A are internal views of door 10; that is, interior surface 14 of door 10 is not illustrated, rather, the construction behind interior surface 14 is seen.

Sections 22 of door 10 can be, and preferably are, constructed using a boxed frame assembly, which is a substantially rectangular border surrounding an interior section. Typically, a boxed frame assembly uses a stile and rail construction technique. Referring to FIG. 6A, section 22B has frame assembly 30 with rails 32 which extend horizontally and stiles 34 which extend vertically. Specifically, frame assembly 30 has a first rail 32A at the top of section 22B and a second rail 32B at the bottom of section 22B, and a plurality of stiles 34 extending therebetween specifically, a first stile 34A (at first side edge 16), second side stile 34B (at second side edge 18), and an internal stile 34C. It should be understood that any or all of sections 22 can have this or a similar boxed frame construction. A first layer of material is positioned over frame assembly 30 to form exterior surface 12 and another layer of material is positioned over the other side of frame assembly 30 to form interior surface 14, as is described further below. Typically, one layer of material is used to on the inside to form interior surface 14; one or more layers of material may be used on the outside of frame assembly 30.

The doors of the present invention include an internal or inset strut in at least one of sections 22. By use of the term “inset”, what is intended is that no portion of the strut extends above the interior surface 14 of door 10. By use of the term “internal”, what is intended is that the inset strut is not visible on the interior surface 14 of door 10, rather, an internal strut is concealed within the interior of door 10. An internal or concealed strut is a type of inset strut.

FIG. 6 shows an interior of door 10 having an inset strut 40 present in various sections 22. In particular, section 22A has inset strut 40A, section 22B has inset strut 40B, and section 22C has inset strut 40C. In this embodiment, door 10 does not include an inset strut 40 on section 22D. FIG. 6A shows section 22B with inset strut 40B. Strut 40 is also shown in FIGS. 7, 8 and 11.

Strut 40 is a reinforcing member for section 22, providing torsional resistance to section 22 and to door 10. Strut 40 also stiffens section 22 and reduces sagging, both when in a vertical orientation (e.g., when door 10 is in a closed orientation) and in a horizontal orientation (e.g., when door 10 is in an open orientation).

Referring to the embodiment of FIGS. 6A, 7 and 8, inset strut 40 is composed of two pieces 40′ and 40″, each having a first arm 42 and a second arm 44 generally at a right angle to first arm 42. Pieces 40′, 40″ can be generally described as L-shaped. The pieces 40′, 40″ are attached to each other via arms 44, for example by welding or by structural adhesive. A corner 45, which is or is close to 90 degrees, is present as a transition between first arm 42 and second arm 44. The four arms 42, 44 provide a T-shape for strut 40.

In alternate embodiments, the inset strut may include only one piece, either 40′ or 40″, but which does preferably have both arms 42, 44; such a strut would be L-shaped. In yet another embodiment, the inset strut may be formed from a single piece to form a T-shape. Other alternate shapes include U and I shapes, and of course other shapes may be suitable.

Strut 40 has a length between a first end 46 and an opposite second end 48, with both arms 42, 44 extending the length of strut 40.

Typically, first arm 42 is about 0.25 inch to 2 inches long, more typically about 0.5 inch to 1 inch long. Second arm 44 is typically about 0.25 to 3 inches long, more typically about 0.5 to 2 inches long. Arms 42, 44 typically have a thickness of 20 to 12 gauge, or thicker or thinner, depending on the material, the shape, and the desired strength.

In one particular embodiment, strut 40 is 114 inches long from end 46 to end 48, arm 42 is 0.75 inch long and arm 44 is 1 inch long. Strut 40 is made from 16 gauge galvanized steel. Holes (spaced 1.5 inches apart) are present in arm 42 to accept a fastener, such as a screw, therethrough, to mount strut 40 to stiles 34. In this embodiment, three holes and fasteners are used for each stile. In an alternate configurations, more or less holes can be used in an configuration.

Referring to FIG. 6, for each of sections 22A, 22B, 22C illustrated having strut 40A, 40B, 40C, respectively, the respective strut 40 is centered height wise in section 22 and extends laterally across at least the majority of the width of section 22, extending short of first side edge 16 and second side edge 18, for example, about 3 inches. It is understood that strut 40 could extend to side edge 16 and/or side edge 18. In FIG. 6A, strut 40B extends from stile 34A, across stile 34C, to stile 34B. Specifically, first end 46 of strut 40B is present on stile 34A short of first edge 16 and second end 48 of strut 40B is present on stile 34B short of second edge 18. Preferably, at inset strut extends at least 50% of the width of the section, more preferably at least 75%, and most preferably at least 90% of the width of the section. For example, a 114 inch long strut, on a 120 inch wide section, would be 95% of the width.

The doors of the present invention additionally or alternately include an internal or inset top reinforcing member in the top section, e.g., section 22D. By use of the term “inset”, what is intended is that no portion of the top reinforcing member extends above the interior surface 14 of door 10. By use of the term “internal”, what is intended is that the inset top reinforcing member is not visible on the interior surface 14 of door 10, rather, an internal top reinforcing member is concealed within the interior of door 10. An internal top reinforcing member is a type of inset top reinforcing member.

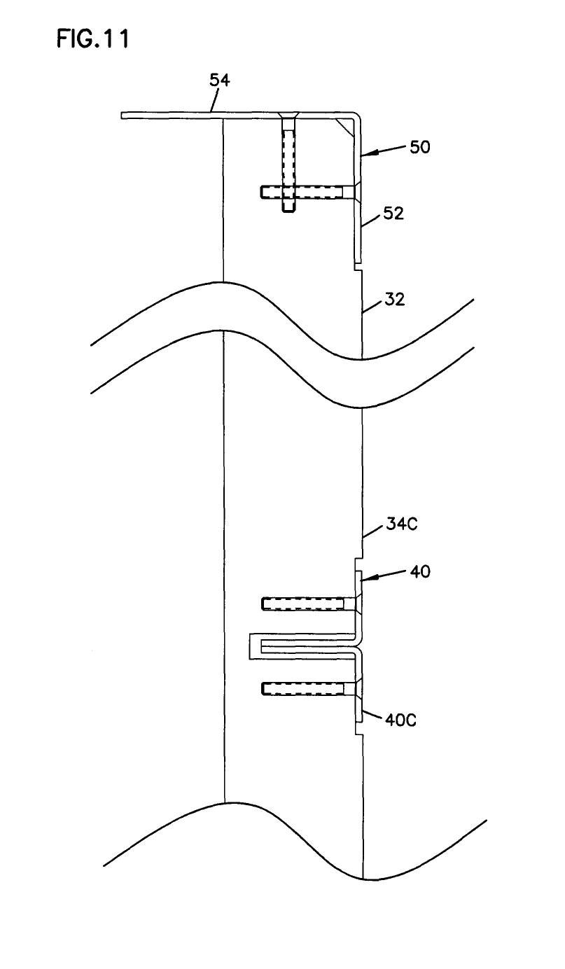

FIGS. 9 and 10 illustrate inset top reinforcing member 50, as does FIG. 11. Inset top reinforcing member 50 is a reinforcing member for the top of door 10, providing torsional resistance to the top section 22D and to door 10. Inset top reinforcing member 50 also stiffens the top section 22D and reduces bowing and sagging, both when in a vertical orientation (e.g., when door 10 is in a closed orientation) and in a horizontal orientation (e.g., when door 10 is in an open orientation).

Inset top reinforcing member 50 has a first arm 52 and a second arm 54 generally at a right angle to first arm 52. A corner 55, which is or is close to 90 degrees, is present as a transition between first arm 52 and second arm 54. Top reinforcing member 50 has a length between a first end 56 and an opposite second end 58.

Typically, first arm 52 is about 0.5 inch to 4 inches long, more typically about 1 inch to 2 inches long. Second arm 54 is typically about 0.5 to 4 inches long, more typically about 1.5 to 3 inches long. Arms 52, 54 are typically 12 to 18 gauge.

In one particular embodiment, inset top reinforcing member 50 is 120 inches long from end 56 to end 58, arm 52 is 1.5 inch long and arm 54 is 2 inches long. Inset top reinforcing member 50 is made from 16 gauge galvanized steel. Holes (spaced approximately 20 inches apart) are present in each of arm 52 and arm 54 to accept a fastener, such as a screw, therethrough, to mount inset top reinforcing member 50 to the top rail of a section. Adhesive may additionally or alternatively be used. In an alternate embodiment, some or all of the holes in arms 52, 54 are approximately 10 inches apart. Preferably, the holes in arm 52 are offset from the holes in arm 54. Such an inset top reinforcing member 50 is suitable for use with “blended” doors. In the context of this application, “blended” doors have one layer over the exterior surface of frame assembly 30, with this one layer optionally being a blend of two materials, e.g., tongue-and-groove framed or surrounded by trim boards.

In another particular embodiment, inset top reinforcing member 50 is 120 inches long from end 56 to end 58, arm 52 is 1.5 inch long and arm 54 is 2.375 inches long. Inset top reinforcing member 50 is made from 16 gauge galvanized steel. Holes (spaced approximately 10 and/or 20 inches apart) are present in each of arm 52 and arm 54 to accept a fastener. Preferably, the holes in arm 52 are offset from the holes in arm 54. Such an inset top reinforcing member 50 is suitable for use with “layered” doors. In the context of this application, “layered” doors have more than one layer over the exterior surface of frame assembly 30. For example, one layer e.g., tongue-and-groove, may have another layer, e.g., trim boards, partially covering the first layer.

Referring to FIG. 6, inset top reinforcing member 50 is present at the top of section 22D and extends across the width of section 22D, extending from first side edge 16 to second side edge 18. It is understood that inset top reinforcing member 50 could extend short of side edges 16, 18, however, top reinforcing member 50 should extend at least 50% of the width of section 22D, more preferably 75%, even more preferably 90%, and most preferably 100% of the width.

FIG. 11 illustrates inset strut 40 mounted in a portion of the door's wood frame assembly, particularly, in center stile 34C, and inset top reinforcing member 50 mounted in a portion of the door's frame assembly, particularly, in a top rail 32. Stile 34C and rail 32 include a recessed portion for receiving strut 40 and reinforcing member 50, respectively. Mechanical fasteners are shown attaching strut 40 and reinforcing member 50 to the wood frame. Adhesive may additionally be used.

If the surface of stile 34C and rail 32 were interior surface 12, inset strut 40 and inset reinforcing member 50 would be flush with interior surface 12. In this embodiment, however, stile 34C, rail 32, strut 40 and reinforcing member 50 would be covered by a material layer that forms interior surface 12; thus, strut 40 and reinforcing member 50 are internal strut 40 and internal reinforcing member 50.

As defined above, an internal or concealed top reinforcing member is defined as one that is not visible on the interior surface 14 of door 10. Thus, arm 52 is concealed. It should be understood that arm 42 of top reinforcing member 50 may be visible when one looks down onto the top of section 22D.

For a wood door, frame assembly 30, which includes rails 32 and stiles 34, are made from wood, although a wood composite material may also be used. Although screws, bolts, nails and other metal fasteners may be used to hold together frame 30, frame 30 is considered a wood structure. With a wood structure, a cope and stick technique is preferably used to join frame 30 together.

Generally any wood material is suitable for rails 32 and stiles 34, although a preferred material is Douglas Fir, Southern Yellow Pine, or other wood having similar or greater strength and density. A suitable size for rails 32 and stiles 34 is common 2×4 or 2×6 dimensioned lumber, although other sizes can be used.

Frame assembly 30 is preferably constructed using a pocket hole attachment system, which is a well-known attachment construction known in the wood construction arts. A bore is provided angled through the first piece of wood (e.g., stile 34) into the second piece of wood (e.g., rail 32). The bore is sized and shaped so that the head of a fastener, such as a wood screw, is seated within the first piece, and the fastener extends into the second piece. Preferred fasteners for this application include 2 inch hardened steel screws. An adhesive may be included in the joint between rails 32 and stiles 34.

Preferably, present over frame assembly 30 and, inset struts 40, is at least one layer of material, preferably wood, which forms interior surface 14. Additionally, at least one layer of material, preferably wood, is present over frame assembly to form exterior side or surface 12. Often, multiple layers are used to form a decorative surface for surface 12.

Examples of suitable wood layers for surfaces 12, 14 include solid wood boards, plywood, OSB, chip board, and the like. Suitable thickness for these layers include 3/16 inch, ¼ inch, ⅜ inch, ½ inch, and ⅝ inch.

As mentioned above, exterior surface 12 preferably includes a decorative façade. This façade may be formed from any combination of layers, such as tongue and groove combined with dimensional boards. Examples of suitable woods for decorative layers include No. 3 Western Cedar, Oak, Cherry, Mahogany, Poplar, Yellow Pine, Redwood, spruce, Fir, Maple, Douglas Fir, Birch, Teak, Hickory, Cyprus, and No. 2 Aspen, Western Pine, Eastern Pine and Ponderosa Pine, and other such wood materials. Suitable thicknesses for decorative layers include any thickness from ⅛ inch to 1 inch. In one particular construction, a decorative layer is ¾ inch thick red cedar plywood and ¾ inch thick cedar face boards are used as decorative trim boards. In another particular construction, a decorative layer is 9/16 inch thick v-groove facing. When trim boards are placed on top of the decorative layer, e.g., cedar plywood or v-groove facing, the resulting section or door is referred to as a “layered” section or door. When trim boards are placed adjacent to (i.e., not on top of) the decorative layer, the resulting section or door is referred to as a “blended” section or door.

The decorative layers, such as decorative plywood and/or decorative trim boards, can be attached to frame 30 and any other exterior layer by any suitable fastening system, including mechanical fasteners (e.g., nails, screws, staples, etc.), chemical attachment (e.g., adhesives), or any combination.

An insulation material may be positioned in an interior area of section 22, within frame 30 between rails 32 and stiles 34. As example of a suitable insulation material is 1⅜ inch thick polystyrene insulation, either expanded or extruded.

Inset struts 40 and inset top reinforcing member 50 can be made from any suitable material such as metal, plastic, composites, or even wood or wood composites, but it is preferred that metal (e.g., galvanized steel, stainless steel, steel, iron, or aluminum) forms struts 40 and member 50. Struts 40 and member 50 can be attached to section 22 by any suitable fastening system, either mechanical or chemical, or a combination. Mechanical attachment systems include screws, nails, bolts, staples, and the like. Chemical attachment systems use adhesive or glue. If an adhesive or glue is used, any metal pieces should be cleaned with a cleaner to remove any oily residues from the surface in order to promote better adhesion. Any or all of struts 40, top reinforcing member 50, and mechanical fasteners used to attach struts 40 and/or member 50 can be treated or coated, such as powder coated.

The various embodiments described above are provided by way of illustration only and should not be construed to limit the invention. For example, doors according to the present invention may include a combination of inset strut(s) and conventional strut(s). Or, doors according to the present invention may include conventional strut(s) with an inset top reinforcing member, or, inset strut(s) with a conventional top reinforcing member. Those skilled in the art will readily recognize additional modifications and changes that may be made to the present invention without following the example embodiments and applications illustrated and described herein, and without departing from the true spirit and scope of the present invention, which is set forth in the following claims.

What is claimed:

1. A wood door comprising:
(a) a plurality of sections hingedly connected, each of sections comprising:
(i) a wooden internal frame having a first side, an opposite second side, a first side edge and an opposite second side edge;
(ii) a first layer present over the first side and a second layer present over the second side, each of the first layer and the second layer covering the internal frame;
(b) at least one of the sections comprising an inset strut extending laterally across the section between the first side edge and the second side edge, with no portion of the inset strut extending above a surface of the first layer.

2. The door of claim 1, wherein the inset strut is recessed into the first layer.

3. The door of claim 2, wherein the inset strut comprises a T-shape.

4. The door of claim 2, wherein the inset strut comprises two pieces.

5. The door of claim 4, wherein the inset strut comprises two L-shape pieces.

6. The door of claim 2, wherein at least two of the sections comprises a recessed strut.

7. The door of claim 1, wherein the inset strut is present between the frame and the first layer.

8. The door of claim 7, wherein the inset strut comprises a T-shape.

9. The door of claim 7, wherein the inset strut comprises two pieces.

10. The door of claim 9, wherein the inset strut comprises two L-shape pieces.

11. The door of claim 7, wherein at least two of the sections comprises an inset strut.

12. The door of claim 1, wherein at least one of the sections comprises an inset top reinforcing member.

13. A section for a door, the section comprising:
(a) a wooden internal frame having a first side, an opposite second side, a first side edge and an opposite second side edge;
(b) a first layer present over the first side and a second layer present over the second side, each of the first layer and the second layer covering the internal frame; and
(c) an inset strut extending laterally across the section between the first side edge and the second side edge, with no portion of the inset strut extending above a surface of the first layer.

14. The door of claim 13, wherein the inset strut is recessed into the first layer.

15. The door of claim 14, wherein the inset strut comprises a T-shape.

16. The door of claim 14, wherein the inset strut comprises two pieces.

17. The door of claim 16, wherein the inset strut comprises two L-shape pieces.

18. The door of claim 13, wherein the inset strut is present between the frame and the first layer.

19. The door of claim 18, wherein the inset strut comprises a T-shape.

20. The door of claim 18, wherein the inset strut comprises two pieces.

21. The door of claim 20, wherein the inset strut comprises two L-shape pieces.
